(19) United States
(12) Patent Application Publication
(10) Pub. No.: US 2010/0007524 A1
(43) Pub. Date: Jan. 14, 2010

(54) ADVERTISING OR ROAD INFORMATION SCREEN SYSTEM INTEGRATED TO TRAFFIC LIGHT CONTROLS

(76) Inventor: Alejandro Brunell Gonzalez, Nuevo Leon (MX)

Correspondence Address: Glast, Phillips & Murray, P.C, 13355 Noel Road, Suite 2200, Dallas, TX, 75240, US

(21) Appl. No.: 12/245,179

(22) Filed: Oct. 3, 2008

(30) Foreign Application Priority Data
Jul. 9, 2008 (MX) MX/U/2008/000210

(51) Int. Cl. G08G 1/09

(52) U.S. Cl. 340/905

(57) ABSTRACT

A system for providing advertising and road information has at least one display screen, a first system to switch the display screen between the display of advertising information and road information, a traffic light controller, and a communication system operatively connected to the display screen and the traffic light controller. The traffic light controller is adapted to selectively control the display of advertising and road information on the display screen. The system can thus display advertising information when the traffic controller commands the traffic to stop at the traffic light, selectively along with road information, and to display road information alone when traffic is flowing.

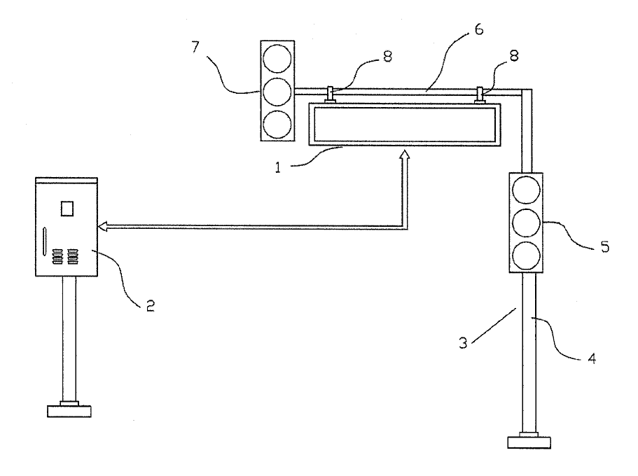

### CLAIM FOR PRIORITY

This application claims the priority of Mexican Patent Application, serial no. MX/u/2008/000210, filed Jul. 9, 2008, having the title “Sistema de pantallas publicitarias Y/o viales integradas a controladores de semáforos,” which application is incorporated by reference into the present application.

### BACKGROUND

1. Technical Field

This disclosure relates to promotion, advertising and display of products, brands, logos, mottos, instructions, etc. in lighted media integrated with traffic light signals.

2. Background Art

Currently, it is widely known of the existence of different advertisements, structures and advertising shells that allow for products, brands, logos, messages, etc. to be displayed to the public; providing a greater reach and impact those advertisements that include eye-catching, attractive and elegant structures.

Meanwhile, it is widely known that in the world's large cities, car and pedestrian traffic has been increasing uncontrollably, which has generated an endless number of problems, such as street congestions, accidents, pollution, slowing of driving speed, people getting late to work, the office, and to school. This has led to the implementation of a traffic control system consisting of a number of traffic lights that control traffic throughout the city streets.

Traffic lights are generally placed at the intersecting points of different streets with the intent of controlling intersections and preventing overcrowding and car accidents.

Traffic lights are configured in such a way that they control traffic according to crowding, time, speed, location of intersection, etc. Therefore, programmable traffic lights control systems are used, and they can control the light's on and off function, times, light changing, etc.

The time that drivers spend stuck in their cars during red lights, along a drive during the day, is an extended period of time where drivers closely watch the change of lights in order to proceed forward.

The time when drivers are stopped is of great value from the advertising point of view; therefore, the placement of advertisements in visible areas is of great relevance, especially on the traffic light structure itself.

It would be advantageous to have an advertising system integrated with the traffic light control system. Some of the advantages would be:
an advertising screen system integrated to the traffic light controls, thus allowing the display of advertisements or road information before, during and after stopping at the traffic light;
providing such advertising or road information screens integrated to traffic light controls to also allow screens or panels to be attractive, thus visually impacting the consumer and the general public;
providing such advertising or road information screens integrated to traffic light controls to also facilitate the personalization of information and advertisements;
providing such advertising or road information screens integrated to traffic light controls by also being cost-effective in their production and sale, and being subject to be used at huge volumes.
providing such advertising or road information screens integrated to traffic light controls to also allow the placement of different sized and resolution screens, depending on the intersection's dimension, and also allowing a great flexibility in the kind of information that can be displayed; and,
providing such advertising or road information screens integrated to traffic light controls to also allow the alternating display of advertising and road information, such as names, preventive signals, restrictive signals, etc.

### DRAWINGS

The sole FIGURE shows the preferred embodiment of the system of advertising or road information screens integrated to traffic light controls.

### SUMMARY

Generally speaking, the system of advertising or road information screens integrated to traffic light controls consists of at least one advertising screen, preferably an LED, with an integrated system, that can also be external through a digital memory, to switch between the advertisement and road information displays; a traffic light controller adjusted to control such integrated system of at least one advertising screen, one communication system between the controller and one screen, and it can operate through wires or wirelessly.

At least one screen is adjusted to be affixed onto the traffic light structure.

At least one LED screen will display traffic information when the traffic light is on green for the corresponding traffic lanes; when the traffic light turns red for the corresponding traffic lanes, the controller will send information to at least one screen so it can display advertising and road information. Traffic information can also be programmed depending on the system's needs.

### DETAILED DESCRIPTION

In reference to the FIGURE, the preferred system of advertising or road information screens integrated to traffic light controls comprises at least one LED advertising screen 1. The screen includes an integrated system (not shown) to switch between the displaying of advertising and road information; a traffic light controller 2 adjusted to control such integrated system of at least one advertising screen 1 and one communication system (not shown) between such controller 2 and the advertising screen 1, which can operate through wires or wirelessly.

The traffic light 3 generally consists of one pole 4 in which the light structure 5 can be affixed, and it can also include a transversal arm 6 which supports a second light structure 7.

The advertising screen 1 includes a mounting media 8 adjusted for its mounting either on the traffic light pole 4, or in the transversal arm 6. Since this is the area the driver keeps in his viewing angle while the traffic light is in red, and the driver is watching closely while waiting for the green light, the screen 1 remains in the driver's viewing angle. At least one screen 1 will display traffic information when the traffic light 3 is showing green for the corresponding traffic lanes. When the traffic light 3 turns red for the corresponding traffic lanes, the controller 2 will send information to at least one screen 1 so it displays advertising and road information. Traffic information can also be programmed for display on the screen 1, depending on the system's needs.

I claim:

1. A system for providing advertising and road information comprising:
at least one display screen;
a first system to switch the display screen between the display of advertising information and road information;
a traffic light controller;
a communication system operatively connected to the display screen and the traffic light controller; and,
the traffic light controller adapted to selectively control the display of advertising and road information on the display screen.

2. The system for providing advertising and road information of claim 1, where the traffic light controller is further adapted to selectively control the display of advertising information on the display screen so that advertising is displayed on the display screen when the traffic controller has signaled traffic to stop.

3. The system for providing advertising and road information of claim 1, where the display screen is an LED screen.

4. The system for providing advertising and road information of claim 1 further comprising:
a mounting structure;
the mounting structure affixed to the display screen;
the mounting structure adapted to be further affixed to one of a traffic light pole or a traffic light transversal arm.

5. The system for providing advertising and road information of claim 1 where the communication system operates by means of a wireless connection.
